(19) United States
(12) Patent Application Publication
(10) Pub. No.: US 2025/0137969 A1
(43) Pub. Date: May 1, 2025

(54) PRODUCT QUALITY MEASURING APPARATUS

(71) Applicant: ELECTRONICS AND TELECOMMUNICATIONS RESEARCH INSTITUTE, Daejeon (KR)

(72) Inventors: Cheol Hyo LEE, Daejeon (KR); Hae Dong LEE, Daejeon (KR)

(21) Appl. No.: 18/925,219

(22) Filed: Oct. 24, 2024

(30) Foreign Application Priority Data
Oct. 25, 2023 (KR) 10-2023-0143451

(51) Int. Cl. G01N 29/04; B23K 26/362; G01N 29/22

(52) U.S. Cl. CPC G01N 29/04; B23K 26/362; G01N 29/225; G01N 2291/0231; G01N 2291/0289; G01N 2291/101

(57) ABSTRACT

Provided is a product quality measuring apparatus that inspects quality of a product by measuring an internal state, a weight, and a volume of the product. To this end, the apparatus includes an inspection module that inspects at least one of the internal state, the weight, and the volume of a product and a quality analyzing module that analyzes the quality of the product by analyzing data received from the inspection module.

### CROSS-REFERENCE TO RELATED APPLICATION

This application claims priority to and the benefit of Korean Patent Application No. 10-2023-0143451 filed on Oct. 25, 2023, the disclosure of which is incorporated herein by reference in its entirety.

### BACKGROUND

### 1. Field of the Invention

The present invention relates to a product quality measuring apparatus.

### 2. Description of Related Art

A molding process for making a product having a specific shape rather than a powder form is essential after mixing or processing materials such as metal, plastic, and ceramic. In this case, unexpected defective products may be generated in a process of making a product having desired properties according to distribution of the materials, a molding method, or the like. A quality inspecting process for removing the defective products may be required while an additional process for completing a final product after the molding is performed.

There are various limitations in identifying internal states or defects of the product without cutting the product after the product having a specific shape is molded. Various inspecting methods may be applied to the molded product depending on a shape, a size, a material, and a strength thereof.

In general, a non-destructive inspecting method may be used as a product inspecting method that minimizes changes of the shape and a function of the product without disassembling the product. Further, density information of the manufactured product may be indirectly identified using information on a volume and weight of the molded product to identify characteristics of the product.

The background art of the present invention is disclosed in Korean Patent Application Publication No. 10-2015-0095053 (2015.08.20.).

### SUMMARY OF THE INVENTION

The present invention is directed to providing a product quality measuring apparatus capable of inspecting quality of a product by measuring an internal state, a weight, and a volume of the product.

According to an aspect of the present invention, there is provided a product quality measuring apparatus including an inspection module that inspects at least one of an internal state, a weight, and a volume of a product, and a quality analyzing module that analyzes quality of the product by analyzing data received from the inspection module.

The inspection module and the quality analyzing module may be connected to each other through power line communication (PLC) communication and transmit and receive the data therebetween.

The inspection module may include a weight measuring unit that measures the weight of the product, a volume measuring unit that measures the volume of the product, and an ultrasonic inspecting unit that measures the internal state of the product through data acquired by scanning an ultrasonic wave to the product.

The product quality measuring apparatus may further include a laser etching unit that engraves identification information on a surface of the product.

The inspection module may further include a transport unit that transports the product along the ultrasonic inspecting unit, the weight measuring unit, the volume measuring unit, and the laser etching unit.

The quality analyzing module may include a data acquiring unit that collects and stores the data from the inspection module, and a calculation unit that measures the quality of the product by analyzing the data collected by the data acquiring unit through an artificial intelligent model.

The quality analyzing module may further include an environment sensor that measures an environment inside a workplace in which the inspection module is installed.

The quality analyzing module may further include a control unit that remotely monitors the data received from the inspection module or the calculation result by the calculation unit or provides the data and the calculation result that are visualized in a graph or a text.

According to another aspect of the present invention, there is provided a product quality measuring apparatus including a weight measuring unit that measures a weight of a product, a volume measuring unit that measures a volume of the product, an ultrasonic inspecting unit that measures an internal state of the product through data acquired by scanning an ultrasonic wave to the product, a laser etching unit that engraves identification information on a surface of the product, a transport unit that transports the product along the ultrasonic inspecting unit, the weight measuring unit, the volume measuring unit, and the laser etching unit, and a frame assembly in which the ultrasonic inspecting unit, the weight measuring unit, the volume measuring unit, the laser etching unit, and the transport unit are arranged.

The product quality measuring apparatus may further include a worktable assembly in which the weight measuring unit and the volume measuring unit are arranged to measure the weight and the volume of the product or in which the laser etching unit is disposed to etch the product, and a work arrangement unit assembly in which the ultrasonic inspecting unit is disposed and which arranges the product so that the ultrasonic inspecting unit performs ultrasonic inspection.

The worktable assembly may include a shuttle frame that transports the product, and the shuttle frame may include a first holder lift that holds the product and vertically transports the product, a second holder lift that holds the product and vertically transports the product, a joint plate that fixedly supports the first holder lift and the second holder lift, and a shuttle cylinder that adjusts a position of the joint plate.

The weight measuring unit may be mounted on the second holder lift to measure the weight of the product.

The first holder lift may include a first lift assembly that raises or lowers a lift, a grapher assembly that fixedly moves the product, and a dummy appliance that maintains an entire height of the first holder left constant.

The dummy appliance may be replaced with the weight measuring unit.

The second holder lift may include a first lift assembly that raises or lowers the lift, and a grapher assembly that fixedly moves the product, and the weight measuring unit may be installed in the grapher assembly.

The volume measuring unit may measure a distance from the product using a laser in three directions and measure the volume of the product using the measured distance.

The volume measuring unit may acquire scan data by scanning the product and measure the volume of the product by analyzing the acquired scan data.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram of a product quality measuring apparatus according to an embodiment of the present invention;

FIG. 2 is a diagram of a frame of the product quality measuring apparatus according to the embodiment of the present invention;

FIG. 3 is a diagram of a shuttle frame for transporting a product according to the embodiment of the present invention;

FIG. 4 is a diagram of an ultrasonic inspecting assembly according to the embodiment of the present invention;

FIG. 5 is a diagram of a first general holder lift according to the embodiment of the present invention;

FIG. 6 is a diagram of a second weight holder lift according to the embodiment of the present invention;

FIG. 7 is a diagram of a volume measuring device according to the embodiment of the present invention; and

FIGS. 8A-8D are views illustrating a method of operating a quality inspecting apparatus according to the embodiment of the present invention.

### DETAILED DESCRIPTION OF EXEMPLARY EMBODIMENTS

Hereinafter, a product quality measuring inspecting apparatus and method according to an embodiment of the present invention will be described. In this process, the thickness of lines or the size of components illustrated in the drawings may be exaggerated for clarity and convenience of description. Further, terms described below are terms defined in consideration of functions in the present invention and may change according to the intention or custom of a user or an operator. Therefore, definitions of these terms should be made based on the contents throughout the specification.

A product quality measuring inspecting apparatus according to an embodiment of the present invention is adapted to determine internal defects and physical properties of a product and may perform ultrasonic inspection, weight measurement, and volume measurement for a refractory product.

In some embodiments of the present invention, the refractory product is illustratively described, and the type of product is not particularly limited thereto.

The product quality measuring inspecting apparatus according to the embodiment of the present invention may start operation of an inspecting process after the product is transported from the outside using a mechanical device such as a robot arm and the refractory product is placed on a holder.

The product quality measuring inspecting apparatus according to the embodiment of the present invention may perform the ultrasonic inspection, the weight measurement, and the volume measurement for the refractory product placed on a table in this order, but the performance order is not particularly limited thereto.

In the product quality measuring inspecting apparatus according to the embodiment of the present invention, the weight measurement and the volume measurement may be performed on the same holder without limitations on functions thereof or may be performed on different holders.

In the product quality measuring inspecting apparatus according to the embodiment of the present invention, laser etching may be added as needed and may be used for an additional inspecting task by adjusting a function of the holder.

The product quality measuring inspecting apparatus according to the embodiment of the present invention may discharge the refractory product for which an inspection procedure is completed from a final holder to the outside using a mechanical device such as a robot arm.

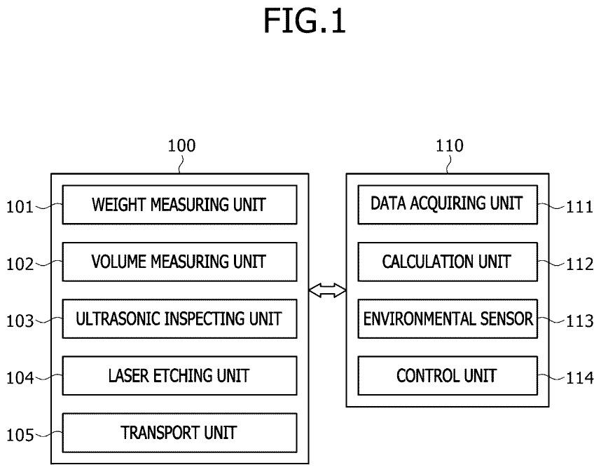

FIG. 1 is a block diagram of a product quality measuring inspecting apparatus according to the embodiment of the present invention.

Referring to FIG. 1, the product quality measuring inspecting apparatus according to the embodiment of the present invention may include an inspection module 100 and a quality analyzing module 110.

The inspection module 100 and the quality analyzing module 110 may be connected to each other through a network and may transmit and receive data therebetween.

The inspection module 100 may include a weight measuring unit 101, a volume measuring unit 102, an ultrasonic inspecting unit 103, a laser etching unit 104 and a transport unit 105.

The weight measuring unit 101 may be provided with a load cell that measures a weight of the refractory product. The load cell may be provided below a grapher on which the refractory product is placed.

The load cell may be a digital load cell, but the present invention is not particularly limited thereto.

The digital load cell may digitally measure the weight of the refractory product when the refractory product is stopped while held thereon.

The volume measuring unit 102 may measure a volume of the refractory product using a laser.

The volume measuring unit 102 may be equipped with a device having a separate linear motion system on a holder and may measure a distance between the laser and the refractory product while precisely moving the laser. The volume measuring unit 102 may calculate the total volume of the refractory product using a distance between the refractory products.

In the embodiment, it is described as an example that a volumetric distance of the refractory product may be measured using the laser and the volume of the refractory product may be measured based thereon. However, the volume measuring unit 102 is not limited to the above-described embodiment and may measure the volume of the refractory product by analyzing data obtained in various laser scanning methods such as point scanning or line scanning for the refractory product.

Further, the volume measuring unit 102 may measure the volume of the refractory product by photographing the refractory product and analyzing the photographed image.

That is, the method of measuring the volume of the refractory product by the volume measuring unit 102 is not particularly limited thereto.

The ultrasonic inspecting unit 103 may scan ultrasonic waves on the refractory product and determine internal defects of the refractory product based on the acquired data.

The ultrasonic inspecting unit 103 may use a two-axis robot arm to bring a transducer into close contact with a measurement area of the refractory product. In this case, the ultrasonic inspecting unit 103 may acquire data by scanning the ultrasonic waves on the refractory product. The ultrasonic inspecting unit 103 may determine the internal defects in the refractory product by analyzing the acquired data.

The laser etching unit 104 may engrave identification information on a surface of the refractory product.

The identification information may be a serial number for identifying information on the refractory product, but the form of the identification information is not particularly limited thereto.

The transport unit 105 may transport the product according to an inspection order. To this end, the transport unit 105 may include a holder for holding the refractory product, a shuttle for moving the refractory product, and an external structure.

The weight measuring unit 101, the volume measuring unit 102, the ultrasonic inspecting unit 103, the laser etching unit 104 and the transport unit 105 may be equipped with power line communication (PLC) devices. The weight measuring unit 101, the volume measuring unit 102, the ultrasonic inspecting unit 103, the laser etching unit 104 and the transport unit 105 and may transmit or receive and control data through the PLC devices so that an appliance may move and may exchange information required for the weight measurement, the volume measurement, the ultrasonic inspection, and the laser etching therebetween.

In some embodiments of the present invention, it is described as an example that the weight measuring unit 101, the volume measuring unit 102, the ultrasonic inspecting unit 103, the laser etching unit 104 and the transport unit 105 perform PLC communication, but a communication method therebetween is not particularly limited thereto.

The quality analyzing module 110 may store, analyze, and manage various pieces of data received from the inspection module 100. That is, the quality analyzing module 110 may receive the data from the inspection module 100, store the data, and analyze and manage quality of the product by analyzing the stored data.

For data exchange between the inspection module 100 and the quality analyzing module 110, a network should be formed between the weight measuring unit 101, the volume measuring unit 102, the ultrasonic inspecting unit 103, the transport unit 104, the laser etching unit 105, and the quality analyzing module 110. However, the inspection module 100 and the quality analyzing module 110 may be equipped with general-purpose communication lines such as Ethernet to form a network as needed, so that the data may be freely exchanged therebetween.

The quality analyzing module 110 may include a data acquiring unit 111, a calculation unit 112, an environmental sensor 113, and a control unit 114.

The data acquiring unit 111 may collect and store data transmitted from the inspection module 100 through the PLC. The data acquiring unit 111 may be equipped with a dedicated or general-purpose device required for acquiring the data, and therefore may perform data interworking with the inspection module 100 and data storage.

The calculation unit 112 may perform independent computing in the form of a small embedded board. The calculation unit 112 may be operated while equipped with an artificial intelligence model such as machine learning and deep learning on the data collected by the data acquiring unit 111. The calculation unit 112 may analyze the data acquired through the data acquiring unit 111 to measure quality of the refractory product.

The environmental sensor 113 may measure an environment within a workplace in which the inspection module 100 is installed.

The environmental sensor 113 may include a temperature sensor for measuring the temperature and a humidity sensor for measuring the humidity in the workplace.

The environmental sensor 113 may acquire the data in conjunction with the data acquiring unit 111 or the calculation unit 112. For example, the environmental sensor 113 may measure environmental information in the workplace when the data acquiring unit 111 and the calculation unit 112 are operated.

The control unit 114 may establish a database (DB) server, a web server, or the like to remotely monitor the data received from the inspection module 100 or a calculation result by the calculation unit 112. Further, the control unit 114 may provide visualized information such as graphs or texts to the user.

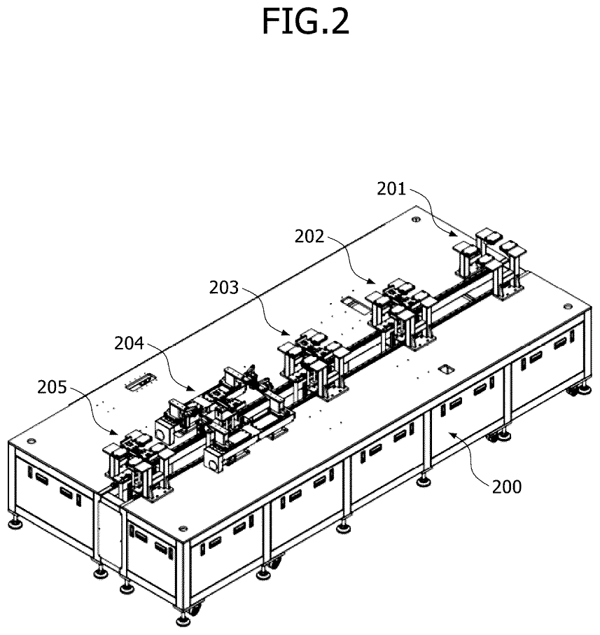

FIG. 2 is a diagram of a frame of the product quality measuring inspecting apparatus according to the embodiment of the present invention.

Referring to FIG. 2, a frame assembly 200 of the product quality measuring inspecting apparatus according to the embodiment of the present invention may be equipped with the holder for holding the refractory product, the shuttle for moving the product, various measuring devices, for example, a structure which is equipped with the weight measuring unit 101, the volume measuring unit 102, the ultrasonic inspecting unit 130, the transport unit 104, and the laser etching unit 105 and a PLC device.

That is, the frame assembly 200 may maintain a structure in which respective devices, for example, the weight measuring unit 101, the volume measuring unit 102, the ultrasonic inspecting unit 103, the transport unit 104, and the laser etching unit 105 are arranged and may be provided with the shuttle, the PLC device, or the like therein.

Worktable assemblies 201, 202, 203, and 205 and a work arrangement unit assembly 204 may be installed in the frame assembly 200.

The worktable assemblies 201, 202, 203, and 204 are appliances that hold the refractory product to facilitate measurement. In particular, the worktable assembly 203 may be used to not only measure the weight but also measure the volume using the linear motion system installed on the holder when the refractory product is held therein.

That is, according to a measurement order for the refractory product, the refractory product may be first held on the worktable assembly 205, may be then moved to and held in the work arrangement unit assembly 204, and may be then subjected to the ultrasonic inspection.

Next, the refractory product may be moved to the worktable assembly 203, and the weight and volume thereof may be measured. That is, the weight measuring unit 101 and the volume measuring unit 102 may be arranged in the worktable assembly 203 to measure the weight and volume of the product.

Next, the refractory product may be moved to the worktable assembly 202, may be subjected to the laser etching, may be then held on the worktable assembly 201, and may be discharged to the outside. That is, the laser etching unit 104 may be disposed in the worktable assembly 202 to etch the refractory product.

The work arrangement unit assembly 204 may arrange the refractory product for ultrasonic measurement. The work arrangement unit assembly 204 may be equipped with a robot module of the ultrasonic inspecting unit 103, and the robot module of the ultrasonic inspecting unit 103 may perform the ultrasonic inspection on the arranged refractory products.

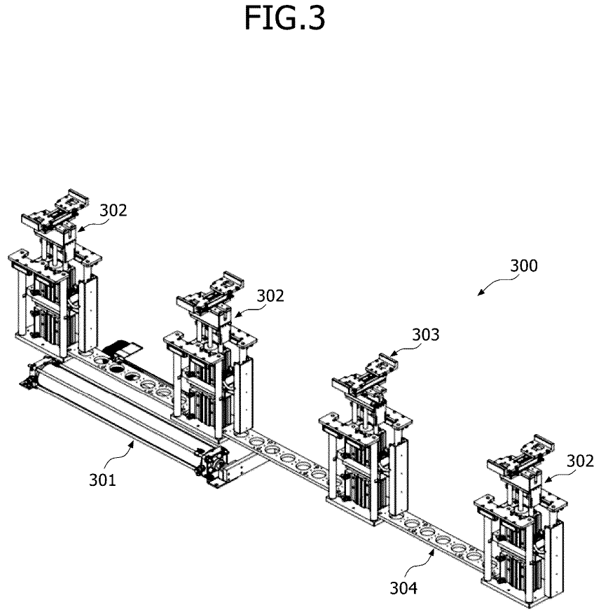

FIG. 3 is a diagram of a shuttle frame for transporting a product according to the embodiment of the present invention.

Referring to FIG. 3, a shuttle frame 300 may include a shuttle cylinder 301, a first holder lift 302, a second holder lift 303, and a joint plate 304. Three first holder lifts 302 may be provided, and one second holder lift 303 may be provided.

The joint plate 304 may fixedly support the first holder lift 302 and the second holder lift 303 and may move the joint plate 304 to simultaneously move the three first holder lifts 302 and the one second holder lift 303.

The shuttle cylinder 301 uses a motor to move the joint plate 304 on which the first holder lift 302 and the second holder lift 303 are placed.

The first holder lift 302 and the second holder lift 303 allow the refractory product to be held on the holder and be vertically transported. Here, the first holder lift 302 may vertically move the refractory product.

Referring to FIG. 3, the three first holder lifts 302 may be provided.

The second holder lift 303 is equipped with the weight measuring unit 101, that is, the load cell, at a lower end of the grapher, and vertically moves.

The load cell may measure the weight of the refractory product when the refractory product is placed on the grapher.

The shuttle cylinder 301 may adjust a position of the joint plate 304.

A process of operating the shuttle frame 300 will be described below.

First, the refractory product may be held on the first holder lift 302 and the second holder lift 303. In this case, both the first holder lift 302 and the second holder lift 303 move to an upper end, and then when the shuttle cylinder 301 is driven to increase a length thereof, four cylinders placed on the joint plate 304 move simultaneously.

After the four cylinders move to a next holder, the first holder lift 302 and the second holder lift 303 are lowered, and in this case, the refractory product is placed on the holder.

Further, the shuttle cylinder 301 is driven again to reduce the length thereof so that the joint plate 304 returns to an initial position.

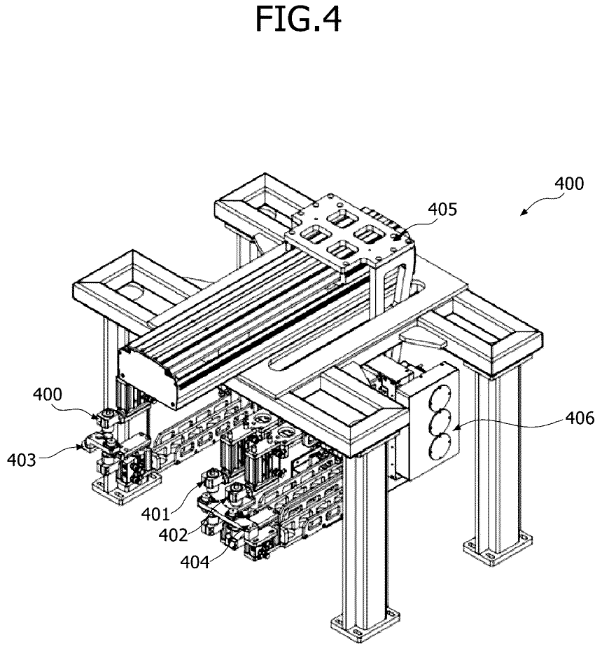

FIG. 4 is a diagram of an ultrasonic inspecting assembly according to the embodiment of the present invention.

Referring to FIG. 4, the ultrasonic inspecting assembly mounts a transducer on the robot arm, moves the robot arm to an ultrasonic measurement position of the refractory product, performs measurement, and then allows the transducer to return to an initial position thereof.

The ultrasonic inspecting assembly may include the ultrasonic inspecting unit 103, three ultrasonic measuring heads 400, 401, and 402, two transducer contact load cells 403 and 404, and two ultrasonic robot assemblies 405 and 406.

The ultrasonic inspecting unit 103 may measure internal quality of the refractory product. The ultrasonic inspecting unit 103 may transmit time series data for an ultrasonic signal to an external device such as the data acquiring unit 111. In this case, the calculation unit 112 may calculate the data obtained by the data acquiring unit 111 using an intelligent algorithm such as machine learning and deep learning.

Three ultrasonic inspecting units 103 may be used, but more ultrasonic measuring units 103 may be mounted as needed.

A multiple ultrasonic inspecting device using a phased array may be employed as the ultrasonic inspecting unit 103.

Further, the ultrasonic inspecting unit 103 may also perform a measuring function by simultaneously using a plurality of transducers.

In the embodiment, three ultrasonic detectors may be used. Accordingly, in the embodiment, an appliance on which three pairs of transducers such as the first ultrasonic measuring head 400, the second ultrasonic measuring head 401, and the third ultrasonic measuring head 402 are held may be provided.

When the ultrasonic transducer moves to a measurement position, the transducer may come into close contact with the surface of the refractory product.

In this case, the first transducer contact load cell 403 and the second transducer contact load cell 404 may measure a pressure when the transducer comes into close contact with the refractory product. In this case, the transducer may be brought into close contact with the surface of the refractory product through a pneumatic device so that a preset pressure may be maintained.

A pneumatic pressure may be used to apply an adhesion force, but the present invention is not particularly limited thereto.

Only two-dimensional movement may be performed to hold the refractory product and move the robot arm to the measurement position. In this case, two robot arms may be used to move the refractory product to (x and y) coordinates. To this end, a two-axis moving device such as the first ultrasonic robot assembly 405 and the second ultrasonic robot assembly 406 may be used. As needed, three robot arms or a multi-joint robot arm may be used to move the refractory product in a three-dimensional space.

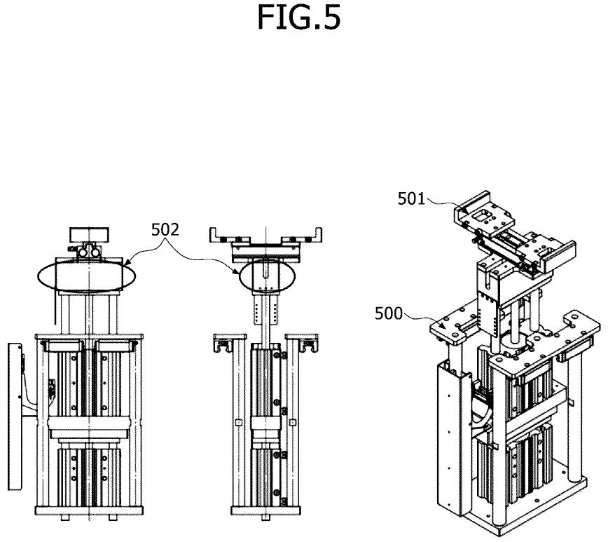

FIG. 5 is a diagram of a first holder lift according to the embodiment of the present invention.

Referring to FIG. 5, the first holder lift 302 may include a first lift assembly 500, a grapher assembly 501, and a dummy appliance 502.

The first lift assembly 500 may have a cylindrical structure and raise or lower the lift using a pressure of an air.

The grapher assembly 501 may place the refractory product thereon, may hold both sides of the refractory product, and may fixedly move the refractory product.

In a process of fixedly holding the refractory product placed on the holders 201, 202, 203, 204, and 205 using the grapher assembly 501 and raising or lowering the first lift assembly 500, the fixed refractory product also moves vertically. Through this process, the refractory product is detached from or placed on the holders 201, 202, 203, 204, and 205.

The dummy appliance 502 may be installed between the first lift assembly 500 and the grapher assembly 501. The dummy appliance 502 may be used to maintain the entire height of the first holder lift 302 constant. The dummy appliance 502 may be replaced with the weight measuring unit 101, that is, the digital load cell, for measuring the weight.

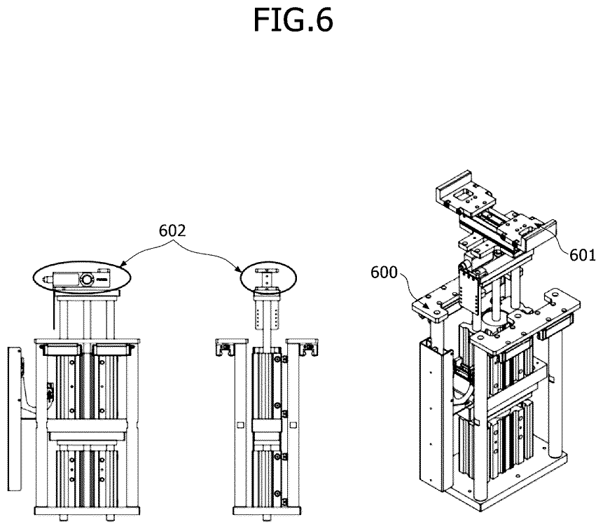

FIG. 6 is a diagram of a second holder lift according to the embodiment of the present invention.

Referring to FIG. 6, the second holder lift 303 may include a second lift assembly 600, a grapher assembly 601, and a weight measuring load cell 602. Functions of the second lift assembly 600 and the grapher assembly 601 may be the same as those of the first lift assembly 500 and the grapher assembly 501, respectively.

The weight measuring load cell 602 may be installed in the grapher assembly 601 and used to measure the weight of the product. Here, the weight measuring load cell 602 may be the weight measuring unit 101.

In the second holder lift 303, the weight measuring load cell 602 is mounted, the grapher assembly 601 is mounted, and thus the refractory product is fixed and vertically moves.

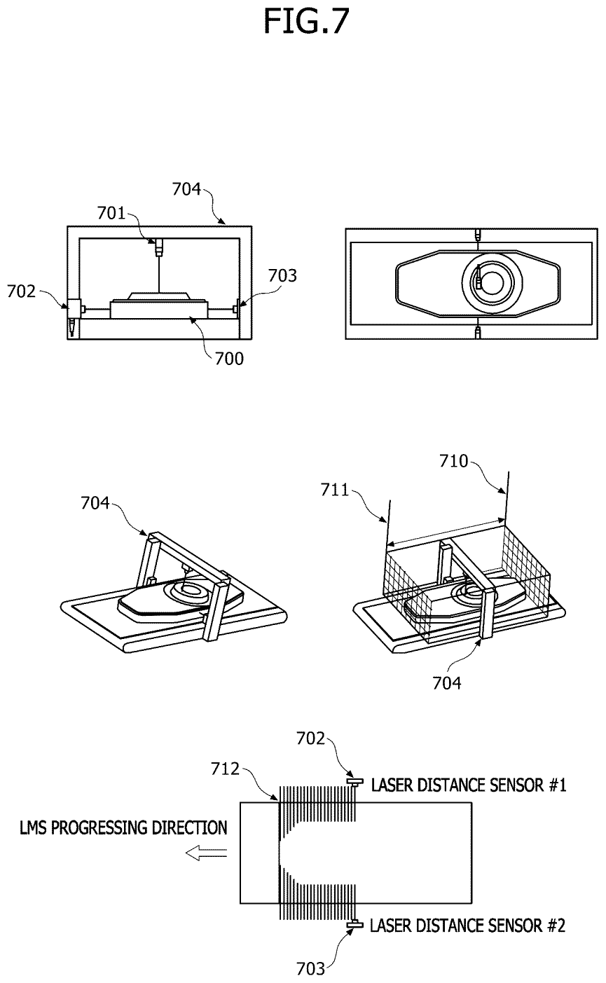

FIG. 7 is a diagram of a volume measuring device according to the embodiment of the present invention.

Referring to FIG. 7, the volume measuring unit 102 may measure the volume of the refractory product using a laser, which is separately from the holder.

When the refractory product 700 is placed on the holder, a frame 704 on which three laser devices 701, 702, and 703 are mounted moves. In this case, the three laser devices 701, 702, and 703 measure distances from an upper side and left and right sides of the refractory product to the product.

The laser frame 704 may measure the distances while moving from a starting point 710 to an ending point 711 at a constant speed by a linear motion system.

An algorithm for reconstructing the volume of the product may calculate the volume value of the product using distance measurement results 712 obtained from the left and right laser devices 702 and 703 and a moving speed of the linear motion system.

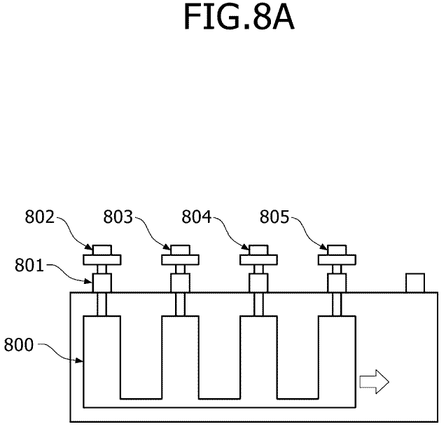

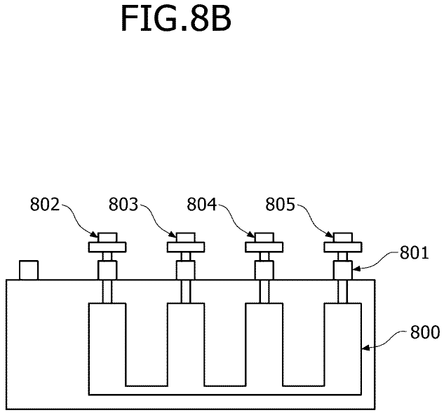

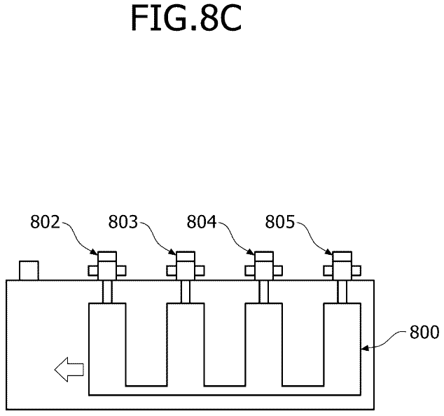

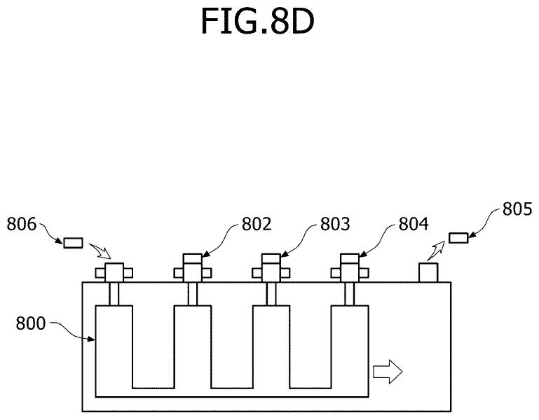

Further, the volume measuring unit 102 may scan the product to obtain scan data and may measure the volume of the product by analyzing the obtained scan data. FIGS. 8A-8D are views illustrating a method of operating a product quality measuring inspecting apparatus according to the embodiment of the present invention.

Referring to FIG. 8A, the product quality measuring inspecting apparatus grips refractory products 802, 803, 804, and 805 placed on a holder 801 mounted on the frame with the grapher. In a structure 800 on which the shuttle frame 300, the first holder lift 302, and the second holder lift 303 are mounted, when the first holder lift 302 and the second holder lift 303 are lifted to an upper end, the four refractory products 802, 803, 804, and 805 are separated from the holder 801 by the first holder lift 302 and the second holder lift 303.

Further, as illustrated in FIG. 8B, the structure 800 on which the shuttle frame 300, the first holder lift 302, and the second holder lift 303 are mounted is horizontally pushed using a cylinder and is moved to a next holder.

When the structure 800 arrives at the next holder 801, the first holder lift 302 and the second holder lift 303 are lowered, and the refractory products 802, 803, 804, and 805 are placed on the holder 801, and as illustrated in FIG. 8C, only the structure 800 on which the shuttle frame 300, the first holder lift 302, and the second holder lift 303 are mounted is moved back to an original position thereof as the cylinder is moved horizontally.

Finally, as illustrated in FIG. 8D, a refractory product 806 to be newly measured is held using the robot arm, and the completely measured refractory product 805 is discharged to the outside using the robot arm.

A product quality measuring apparatus according to an aspect of the present invention can inspect quality of a product by measuring an internal state, a weight, and a volume of the product.

A product quality measuring apparatus according to another aspect of the present invention can minimize human intervention and obtain measurement results having relatively high accuracy.

A product quality measuring apparatus according to still another aspect of the present invention can achieve automated interlocking between front and rear processes and continuously measure quality of a product at regular time intervals, thereby improving product productivity.

A product quality measuring apparatus according to yet another aspect of the present invention can secure digital data in an entire process related to a manufacturing process, perform data analysis to which machine learning and an artificial intelligence technology are applied by linking production process data and an inspection result, and contribute to improving quality of a product and a production process based thereon.

Although the present invention has been described with reference to embodiments illustrated in the drawings, the description is merely illustrative, and those skilled in the art to which the technology belongs should understand that various modifications and other equivalent embodiments may be made. Thus, the technical scope of the present invention should be determined by the appended claims.

Acknowledgment 1. Title of research and development project: Development of a smart inspection system for a composite material/refractory material based on density measurement and ultrasonic defect detection technology using a high-speed precision transport system.

2. Number of research and development project assigned through integrated information system to identify research and development project: 2022-0-00793.

3. Central administrative agency that supports research and development project: A research and development project funded by the Ministry of Science and ICT and supported by the National IT Planning and Evaluation Institute (ICT R&D Innovation Voucher Project).

What is claimed is:

1. A product quality measuring apparatus comprising:
an inspection module configured to inspect at least one of an internal state, a weight, and a volume of a product; and
a quality analyzing module configured to analyze quality of the product by analyzing data received from the inspection module.

2. The product quality measuring apparatus of claim 1, wherein the inspection module and the quality analyzing module are connected to each other through power line communication (PLC) communication and transmit and receive the data therebetween.

3. The product quality measuring apparatus of claim 1, wherein the inspection module includes:
a weight measuring unit configured to measure the weight of the product;
a volume measuring unit configured to measure the volume of the product; and
an ultrasonic inspecting unit configured to measure the internal state of the product through data acquired by scanning an ultrasonic wave to the product.

4. The product quality measuring apparatus of claim 3, further comprising a laser etching unit configured to engrave identification information on a surface of the product.

5. The product quality measuring apparatus of claim 4, wherein the inspection module further includes a transport unit configured to transport the product along the ultrasonic inspecting unit, the weight measuring unit, the volume measuring unit, and the laser etching unit.

6. The product quality measuring apparatus of claim 1, wherein the quality analyzing module includes:
a data acquiring unit configured to collect and store the data from the inspection module; and
a calculation unit configured to measure the quality of the product by analyzing the data collected by the data acquiring unit through an artificial intelligent model.

7. The product quality measuring apparatus of claim 6, wherein the quality analyzing module further includes an environment sensor configured to measure an environment inside a workplace in which the inspection module is installed.

8. The product quality measuring apparatus of claim 6, wherein the quality analyzing module further includes a control unit configured to remotely monitor the data received from the inspection module or the calculation result by the calculation unit or provide the data and the calculation result that are visualized in a graph or a text.

9. A product quality measuring apparatus comprising:
a weight measuring unit configured to measure a weight of a product;
a volume measuring unit configured to measure a volume of the product;
an ultrasonic inspecting unit configured to measure an internal state of the product through data acquired by scanning an ultrasonic wave to the product;
a laser etching unit configured to engrave identification information on a surface of the product;
a transport unit configured to transport the product along the ultrasonic inspecting unit, the weight measuring unit, the volume measuring unit, and the laser etching unit; and
a frame assembly in which the ultrasonic inspecting unit, the weight measuring unit, the volume measuring unit, the laser etching unit, and the transport unit are arranged.

10. The product quality measuring apparatus of claim 9, further comprising:
a worktable assembly in which the weight measuring unit and the volume measuring unit are arranged to measure the weight and the volume of the product or in which the laser etching unit is disposed to etch the product; and
a work arrangement unit assembly in which the ultrasonic inspecting unit is disposed and which arranges the product so that the ultrasonic inspecting unit performs ultrasonic inspection.

11. The product quality measuring apparatus of claim 10, wherein the worktable assembly includes a shuttle frame configured to transport the product, and
the shuttle frame includes a first holder lift configured to hold the product and vertically transport the product, a second holder lift configured to hold the product and vertically transport the product, a joint plate fixedly supporting the first holder lift and the second holder lift, and a shuttle cylinder configured to adjust a position of the joint plate.

12. The product quality measuring apparatus of claim 11, wherein the weight measuring unit is mounted on the second holder lift to measure the weight of the product.

13. The product quality measuring apparatus of claim 11, wherein the first holder lift includes:
a first lift assembly configured to raise or lower a lift;
a grapher assembly configured to fixedly move the product; and
a dummy appliance configured to maintain an entire height of the first holder left constant.

14. The product quality measuring apparatus of claim 13, wherein the dummy appliance is replaced with the weight measuring unit.

15. The product quality measuring apparatus of claim 13, wherein the second holder lift includes:
a first lift assembly configured to raise or lower the lift; and
a grapher assembly configured to fixedly move the product, and
the weight measuring unit is installed in the grapher assembly.

16. The product quality measuring apparatus of claim 9, wherein the volume measuring unit measures a distance from the product using a laser in three directions and measures the volume of the product using the measured distance.

17. The product quality measuring apparatus of claim 9, wherein the volume measuring unit acquires scan data by scanning the product and measures the volume of the product by analyzing the acquired scan data.
